(19) United States
(12) Patent Application Publication
(10) Pub. No.: US 2023/0016971 A1
(43) Pub. Date: Jan. 19, 2023

(54) CALIPER UNIT FOR BRAKE

(71) Applicant: FINETRO CO., LTD., Chungcheongnam-do (KR)

(72) Inventors: Won-Bong CHO, Asan-si (KR); Sung-Ki LEE, Gunsan-si (KR); Yun-Hee KWON, Yongin-si (KR)

(21) Appl. No.: 17/812,882

(22) Filed: Jul. 15, 2022

(30) Foreign Application Priority Data
Jul. 19, 2021 (KR) 10-2021-0094325

(51) Int. Cl. F16D 65/095; F16D 65/00; F16D 55/227; F16D 65/18; F16D 65/847

(52) U.S. Cl. CPC F16D 65/095; F16D 65/0068; F16D 65/0056; F16D 55/227; F16D 65/18; F16D 65/847; F16D 2055/0016

(57) ABSTRACT

Provided is a caliper unit for a brake of a vehicle, in particular, a compact caliper unit capable of reducing a size, a weight, and a production cost of a component and improving fuel efficiency. The caliper unit for the brake includes an inner pad and an outer pad, which press both surfaces of a disc to generate braking force, a torque member fixed to a vehicle body and coupled to be movable forward and backward so that the inner pad and the outer pad press the disc, or the pressing of the inner pad and the outer pad to the disc is released, a caliper housing including a cylinder to which a brake hydraulic pressure is applied and a reaction force support part configured to press the outer pad to the disc, and a piston installed in the cylinder and moving forward and backward depending on a state of the brake hydraulic pressure applied to the cylinder to press the inner pad to the disc. Each of the inner pad and the outer pad has a circular shape, and a contact surface of the piston, which is in contact with the inner pad to press the inner pad during braking, has a circular shape.

### BACKGROUND

The present disclosure relates to a caliper unit for a brake of a vehicle, and more particularly, to a compact caliper unit capable of reducing a size, a weight, and a production cost of a component and improving fuel efficiency.

In general, a brake is an important device used to decelerate or stop a vehicle during driving, and a disc brake and a drum break, which are hydraulic brakes, are being widely used. Recently, in order to improve braking performance in accordance with the trend of high-speed vehicles, disc brakes having less decrease in braking force due to heat dissipation and thermal deformation compared to drum brakes are being widely used.

A disc brake is a brake device that generates braking force by allowing brake pads to forcibly come into close contact with both surfaces of the disc to stop the rotation of the disc, thereby braking the vehicle and includes a disc rotating integrally with the vehicle wheel and a caliper unit pressing the brake pad against the disc to brake the disc by frictional force.

FIG. 1 is a cross-sectional view illustrating a caliper unit in accordance with the prior art, and FIG. 2 is a front view illustrating a coupling state of a torque member and a brake pad in the caliper unit in accordance with the related art.

In constituents of the disc brake, as illustrated in FIG. 1, a caliper unit 10 includes a torque member (also referred to as a ‘carrier’) fixed to a vehicle body, a brake pad 12 disposed inside the torque member 11 and pressing each of both surfaces of the disc 1 to generate braking force, and a caliper housing (also referred to as a ‘piston housing’) coupled to the torque member 11 by using a sliding pin 14 as a medium.

Here, the brake hydraulic pressure generated by a master cylinder during the braking is applied to a cylinder 15 of the caliper housing (piston housing) 13.

In addition, a piston 16 for transmitting the applied brake hydraulic pressure to an inner pad 12 is installed in the cylinder 15 of the caliper housing 13, and a reaction force support part (also referred to as a ‘finger part’) is disposed at an opposite side of the cylinder 15 and the piston 16 in the caliper housing 13.

The brake pad is constituted by an inner pad 12 disposed at a side of the piston 16 and an outer pad (not shown) disposed at an opposite side of the inner pad 12 with respect to the disc 1, and the torque member 1 is installed so that the inner pad 12 and the outer pad are disposed with the disc 1 therebetween.

In FIGS. 1 and 2, in the case of the outer pad disposed at the opposite side of the inner pad 12 with the disc 1 therebetween is hidden by the disc 1 and thus is not shown.

Each of both the inner pad 12 and the outer pad is coupled to the torque member 11 to move forward and backward. For this, a sliding protrusion 17 is disposed on each of the pads 12, and a guide groove 18, into which the sliding protrusion 17 is inserted to be slidable, is defined in a position of the torque member 11, which corresponds to the sliding protrusion.

Thus, while the sliding protrusion 17 is slid in a state of being inserted into the guide groove 18 of the torque member 11, the pad 12 moves in a direction, in which the disc 1 is pressed, or moves in a direction, in which the pressing of the disc is released.

When the brake hydraulic pressure generated by the master cylinder is applied to the cylinder 15 of the caliper housing 13, the piston advances by the brake hydraulic pressure to press the inner pad 12. Here, the inner pad 1 is in close contact with the disc 1, and also, the caliper housing 13 moves due to the reaction between the inner pad 12 and the disc 1 so that the outer pad disposed at the opposite side of the inner pad 12 is in close contact with the disc 1 through the reaction force support part.

As a result, the two pads press and clamp the disc while being in close contact with both surfaces of the disc, and braking force (braking torque) is generated to brake the vehicle by frictional force between the pads and both sides of the disc.

In an electrified vehicle (motor-driven vehicle) that is driven by a motor, such as a hybrid electric vehicle, a battery electric vehicle (BEV), or a fuel cell electric vehicle (FCEV), a regenerative mode is performed, in which vehicle kinetic energy is recovered as electric energy through a power generation operation of the motor during coasting or braking to charge the battery. In an electrified vehicle, a function of the regenerative mode is essential to improve vehicle efficiency and fuel efficiency.

In this manner, in the electrified vehicle that is driven by the motor, when decelerating, regenerative braking by the motor together with friction braking (hydraulic braking) by the existing brake is performed by the motor may be performed, and the braking force required by the vehicle may be satisfied with the regenerative braking and the friction braking (hydraulic braking).

Therefore, in the case of the electrified vehicle, it is seen that a braking environment capable of reducing a braking capacity of the brake when compared to the general internal combustion engine vehicle without a motor has been established. As a result, the need to develop a compact brake optimized for a regenerative braking system of a platform dedicated to the electrified vehicle is emerging.

When the vehicle is decelerated during the driving, an amount of braking force varies depending on the driving environment on the road. However, in most cases, the vehicle slowly and smoothly decelerated through gradual braking rather than sudden braking. In the case of the electrified vehicle, the regenerative braking may be performed to decelerate the vehicle by generating generation resistance in the driving motor during the deceleration, and a significant portion of the total braking force required during the deceleration may be covered by the regenerative braking force.

Thus, in the vehicle in which the regenerative braking by the motor is performed, a replacement cycle of a friction material used during friction braking may increase, and as the use of the friction braking is greatly reduced in the electric vehicle, rust occurs on a surface of the brake disc (rotor).

As a result, the point in time when the sales volume of the electrified vehicles becomes larger than that of the internal combustion engine vehicles is also expected to arrive soon. Therefore, it is necessary to develop a dedicated brake that meets and optimizes the braking force required for the electrified vehicle.

In addition, the caliper unit 10 illustrated in FIGS. 1 and 2 in accordance with the related art has been used in the existing internal combustion engine vehicle in which 100% friction braking is performed, and since a size of the pad 12 and a friction area between the pad and the disc 1 are large, a temperature of the friction material of the pad may easily increase to a high temperature during the braking. Particularly, in the case of the caliper unit in accordance with the related art, since the size of the pad 12 is large, vibration and noise may occur in the pad during the braking.

FIGS. 3 and 4 are views for explaining limitations of the caliper unit in accordance with the prior art. In FIGS. 3 and 4, reference numerals ‘12a’ and ‘12b’ denote a back plate and a friction material constituting the pad 12, respectively.

As illustrated in the drawings, in the caliper unit in accordance with the prior art, the size and area of the pad 12 are very large when compared to a size and cross-sectional area of the piston in the cylinder (referred to as reference numeral ‘16’ in FIG. 1), and the braking pressure acts directly from the piston to the pad on a central area of the pad 12 that is in contact with the piston 16, but reaction force acting in a direction that is opposite to the direction, in which the force applied by the piston acts, acts on the area on which the piston is not in contact with the piston during the repeated braking at high deceleration, in particular, at both ends of the pad.

Thus, more abrasion may occur on the central area of the pad 12 than other portions due to the friction with the disc 1, and as a result, a peel-off phenomenon may occur between the central area of the pad 12, in which abrasion is relatively high in the brake-off state, and the brake disc 1 during the driving of the vehicle. As a result, when the braking torque is fluctuated due to the non-uniformity of the contact surface pressure between the disc and the pad during the braking, judder and noise may be greatly generated.

Particularly, in order for the pad 12 to contact and press the rotating disc 1 during the braking, when the sliding protrusions (referred to as reference numeral ‘17’ in FIG. 1) of both the ends of the pad move to be slid inside the guide groove (referred to as reference numeral ‘18’ in FIG. 1) of the torque member 11, the contact and impact may occur between the sliding protrusion of the pad and the inner surface of the guide groove when the braking torque is fluctuated, and in this case, the vibration and noise may occur.

In addition, in the case of the caliper unit 10 in accordance with the prior art, since a distance between two pin holes at both sides to which two sliding pins 14 are coupled in the torque member 11 is long, a size of the torque member inevitably increases, and as a result, there is a limitation of increasing in cost and weight.

### SUMMARY

The present disclosure provides a compact caliper unit capable of reducing a size, a weight, and a cost of a component and improving fuel efficiency.

The object of the present disclosure is not limited to the object mentioned above, and other objects not mentioned will be clearly understood by those of ordinary skill in the art (hereinafter, referred to as ‘person of ordinary skill’) from the description below.

In accordance with the present invention, a caliper unit for a brake includes: an inner pad and an outer pad, which press both surfaces of a disc to generate braking force; a torque member fixed to a vehicle body and coupled to be movable forward and backward so that the disc is pressed or released by the inner pad and the outer pad; a caliper housing including a cylinder to which a brake hydraulic pressure is applied and a reaction force support part configured to press the outer pad to the disc; and a piston installed in the cylinder and moving forward and backward depending on a state of the brake hydraulic pressure applied to the cylinder to press the inner pad to the disc, wherein each of the inner pad and the outer pad has a circular shape, and a contact surface of the piston, which is in contact with the inner pad to press the inner pad during braking, has a circular shape.

Each of the inner pad and the outer pad may have the same diameter as the contact surface of the piston or have a diameter greater than that of the contact surface of the piston.

The inner pad and the outer pad may include two sliding protrusions disposed at both sides, respectively, wherein the torque member has a guide groove guided to be slid in a state in which each of the sliding protrusion of the inner pad and the sliding protrusion of the outer pad is inserted, and wherein an outer surface of each of the sliding protrusions may have an arc shape, and an inner surface of each of the guide grooves has an arc shape, so that arc-shaped sliding contact is provided between each of the sliding protrusions and the inner surface of each of the guide grooves.

Each of the inner pad and the outer pad may include: a back plate; a friction material which is a portion integrally coupled to the back plate with a heat dissipation plate therebetween and in contact with the disc to press the disc; and the heat dissipation plate coupled to be interposed between the back plate and the friction material.

The heat dissipation plate may include: a front part that is a portion interposed between a surface of the back plate and a surface of the friction material; and a side end cover part integrally disposed along an entire circumference of an edge of the front part to cover a circumferential surface that is a surface of a side end of the back plate, wherein a cross-section of the front part, on which the surface of the back plate and the surface of the friction material are bonded to be in close contact with each other, may have a shape in which a concave-convex shaped part is repeated to increase in bonding force between the surface of the back plate and the surface of the fraction material.

### BRIEF DESCRIPTION OF THE DRAWINGS

Exemplary embodiments can be understood in more detail from the following description taken in conjunction with the accompanying drawings, in which:

FIG. 1 is a cross-sectional view illustrating a caliper unit in accordance with the prior art;

FIG. 2 is a front view illustrating a coupling state of a torque member and a brake pad in the caliper unit in accordance with the prior art;

FIGS. 3 and 4 are views for explaining limitations of the caliper unit in accordance with the prior art.

FIG. 5 is a front view illustrating a coupling state of a torque member and a brake pad in a caliper unit in accordance with the present invention;

FIG. 6 is a cross-sectional view illustrating a state in which a disc is pressed by a piston and a pad of the caliper unit and a friction material in accordance with the present invention;

FIG. 7 is a cross-sectional view taken along line A-A′ of FIG. 6; and

FIG. 8 is a cross-sectional view illustrating a shape of a heat dissipation plate in a pad of the caliper unit in accordance with of the present invention.

### DETAILED DESCRIPTION OF EMBODIMENTS

Specific structural or functional descriptions disclosed in the embodiment of the present invention are only exemplified for the purpose of explaining the embodiments in accordance with the concept of the present invention, and the embodiments in accordance with the concept of the present invention may be implemented in various forms. In addition, it should not be construed as being limited to the embodiments described herein, and it should be understood to include all modifications, equivalents and substitutes included in the spirit and scope of the present invention.

In the present invention, terms such as ‘first’, ‘and/or’ ‘second’ may be used to describe various components, but the components are not limited to the above terms. The above terms are used only for the purpose of distinguishing one component from other components, for example, within the scope not departing from the scope of the rights in accordance with the concept of the present invention, the first component may be named as the second component, similarly, the second component may also be referred to as a first component.

It will also be understood that when an component is referred to as being “connected to” or “in contact with” another component, it can be directly connected to the other component, or intervening components may also be present. It will also be understood that when an component is referred to as being ‘directly connected to’ or ‘in direct contact with’ another component, there is no intervening components. Other expressions for describing the relationship between components, that is, expressions such as “between” and “immediately between” or “adjacent to” and “directly adjacent to”, should be interpreted similarly.

The same reference numerals represent the same components throughout the specification. In the following description, the technical terms are used only for explaining a specific embodiment while not limiting the present invention. In this specification the terms of a singular form may include plural forms unless specifically mentioned. As used in this specification, the meaning of ‘includes (comprises)’ and/or ‘including (comprising)’ specifies a component, a step, an operation and/or an component does not exclude other components, steps, operations and/or components.

Hereinafter, the present invention will be described in detail with reference to the accompanying drawings.

The present invention relates to a caliper unit for a brake of a vehicle, and more particularly, to a compact caliper unit capable of reducing a size, a weight, and a production cost of a component and improving fuel efficiency.

The caliper unit in accordance with the present invention may be applied to an electrified vehicle in which regenerative braking is performed by a motor while driven using the motor, such as an electric vehicle in a broad sense, that is, a hybrid vehicle (HEV), a pure electric vehicle (BEV), or a fuel cell vehicle (FCEV).

Since the caliper unit in accordance with the present invention is reduced in braking force when compared to the caliper unit of the internal combustion engine vehicle (general engine vehicle) in accordance with the prior art, but has a compact configuration, the caliper unit is useful in the electrified vehicle to which the regenerative braking system is applied.

In the electrified vehicle capable of performing the regenerative braking by the motor, total braking torque is satisfied by hydraulic braking torque (friction braking torque) by the brake and the regenerative braking torque by the motor.

Therefore, unlike the general internal combustion engine vehicle in which the regenerative braking is impossible, and thus, the total braking torque has to be borne by the hydraulic braking torque, in the electrified vehicle capable of performing the regenerative braking, the regenerative braking torque partially shares the total braking torque, and thus, a braking capacity of the generating brake generating the hydraulic braking torque may be reduced.

Thus, when compared to the prior art, the braking capacity may be reduced, but the caliper unit having a compact configuration in accordance with the present invention may be mounted on the vehicle so as to be used. In particular, the caliper unit in accordance with the present invention may be used in the electrified vehicle, in which the regenerative braking is performed, and the braking capacity of the hydraulic brake is reduced.

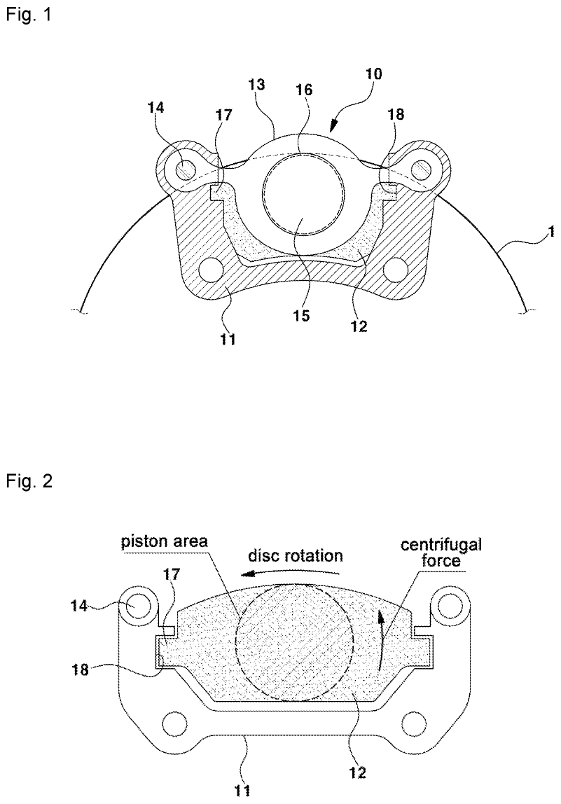

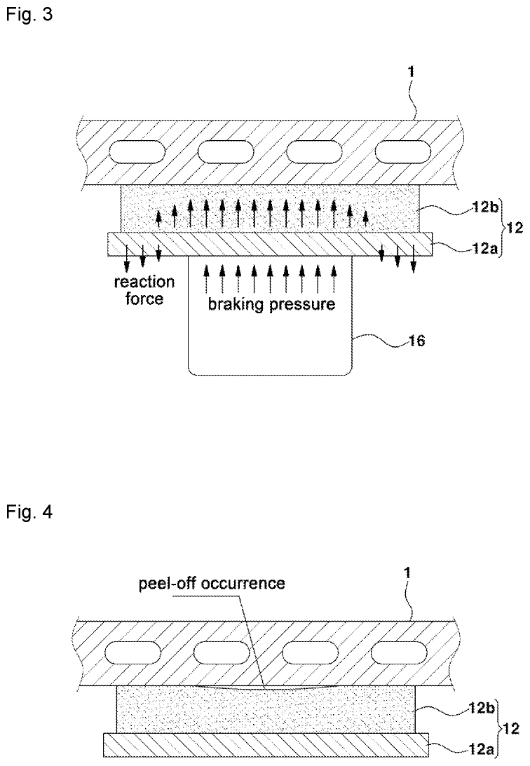

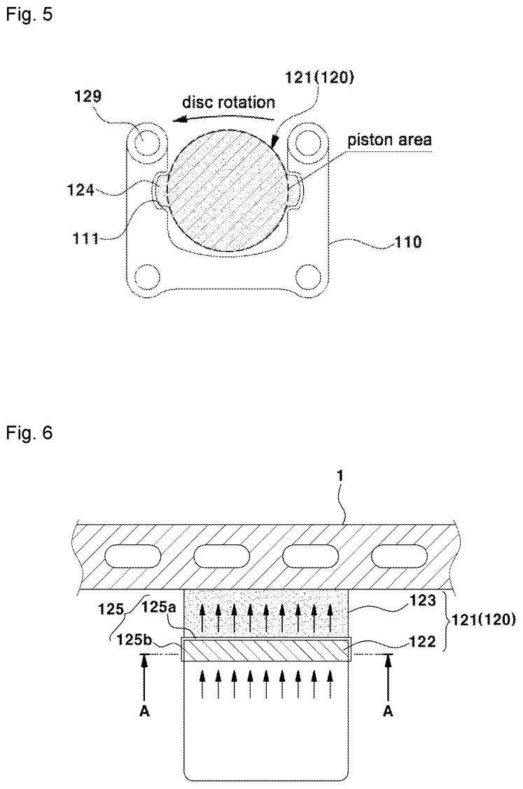

FIG. 5 is a front view illustrating a coupling state of a torque member and a brake pad in a caliper unit in accordance with the present invention; The caliper unit in accordance with the present invention includes a torque member 110 fixed to a vehicle body, a brake pad 120 disposed inside the torque member 110 and pressing both surfaces of a disc (referred to as reference numeral ‘1’ in FIG. 1) to generate braking force, and a caliper housing (referred to as reference numeral ‘13’ in FIG. 1) coupled to the torque member 110 by using a sliding pin 129 as a medium.

Here, the brake hydraulic pressure generated by the master cylinder during the braking is applied to the cylinder (referred to as reference numeral ‘15’ in FIG. 1) of the caliper housing. In addition, the piston (referred to as reference numeral ‘16’ in FIG. 1) that transmits the applied brake hydraulic pressure to the brake pad 120 (an inner pad) is installed in the cylinder of the caliper housing, and a reaction force support part (also referred to as a ‘finger part’) is disposed at an opposite side of the cylinder and the piston in the caliper housing.

The brake pad 120 is constituted by the inner pad 121 disposed at a side of the piston and the outer pad (not shown) disposed at an opposite side of the inner pad with respect to the disc. Here, the caliper unit is the same the caliper unit in accordance with the prior art in that the inner pad and the outer pad are installed on the torque member with the disc therebetween.

The brake pad 120 illustrated in FIG. 5 may be the inner pad 121 pressed by the piston, and the outer pad may have the same shape as that of the inner pad although not illustrated in FIG. 5. As illustrated in FIG. 5, in the caliper unit in accordance with the present invention, a left and right length of the brake pad 120, i.e., a left and right length of the inner pad 121 and the outer pad are significantly reduced.

In addition, in accordance with the present invention, in the inner pad 121 and the outer pad, sliding protrusions may have the same shape, and a back plate 122, a friction material 123, and a heat dissipation plate 125, which will be described later, may have the same configuration. In addition, guide grooves 111 of the torque member 110, to which the sliding protrusions of the two pads are coupled, respectively, may also have the same shape.

In the caliper unit in accordance with the prior art, each of the inner pad and the outer pad has a long left and right length and a predetermined length as illustrated in FIG. 2. However, in the caliper unit in accordance with the present invention, each of the inner pad 121 and the outer pad may have a shape similar to that of an approximately cross-section of the piston (or a shape of a contact surface with the pad, which is shape indicated as ‘piston area’ in FIG. 5).

That is, if the cross-sectional shape of the piston is circular, the overall shape of each of the inner pad 121 and the outer pad may also be circular. A diameter of the inner pad 121 may be the same as that of the piston or be greater from that of the piston by a difference within a set range so that the entire area of the piston evenly contacts and presses the inner pad during the braking.

In this case, the outer pad (not shown) may be provided to have the same diameter and shape as the inner pad 121. As a result, in the caliper unit in accordance with the present invention, a size and weight of each of the inner pad and the outer pad may be reduced when compared to the related art, and thus, the shape and size of the pad may be optimized in the vehicle in which the regenerative braking is performed. In addition, as seen from FIG. 5, since a distance between the two pin holes at both sides to which the sliding pin 129 is coupled in the torque member 110 may be reduced, the overall size and weight of the torque member may also be reduced.

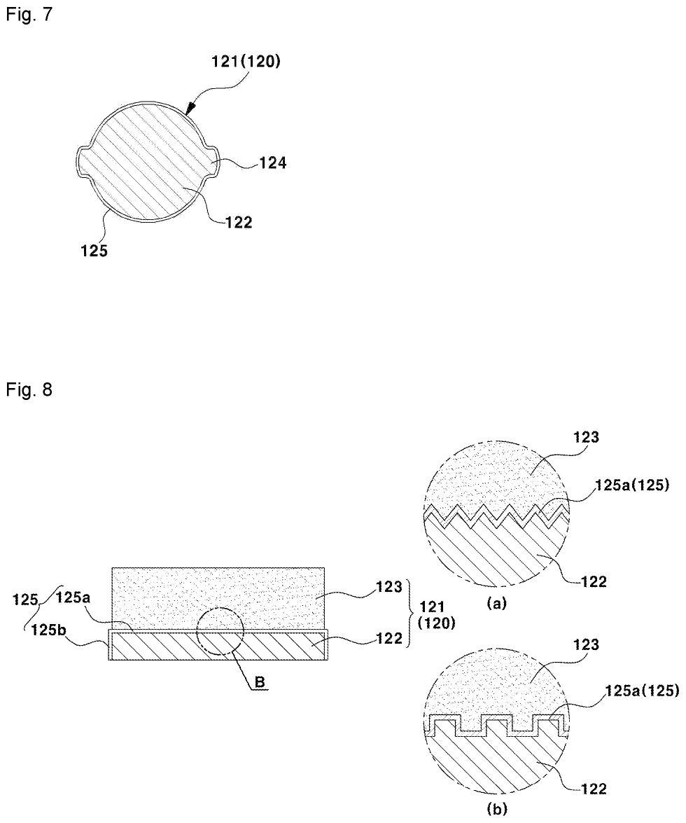

FIG. 6 is a cross-sectional view illustrating a state in which the disc is pressed by the piston and the pad of the caliper unit and the friction material in accordance with the present invention, and FIG. 7 is a cross-sectional view taken along line A-A′ of FIG. 6. As illustrated in the drawings, the brake pad 120, i.e., each of the inner pad 121 and the outer pad (not shown) include a back plate 122 and a friction material 123 integrally coupled to the back plate 122 with a heat dissipation plate, which will be described later, therebetween. Among them, the friction material 1230 is a portion that actually contacts and presses the brake disc and generates braking force through friction with the disc.

Referring to FIG. 6, a shape of the pad 120, i.e., the overall shape of the back plate 122 and the friction material 123 is the same circular shape as the cross-sectional shape of the piston 16 (or the shape of the contact surface with the pad). In this case, a diameter of the back plate 122 and the friction material 123 of the pad may also be the same as that of the piston 16 or be greater than that of the piston 16 by a difference with a set range.

As a result, a size of a pressing surface of the piston 16 and a size of a contact surface of the pad 120 with which the piston 16 is in contact may have the same or similar, and thus the braking pressure (brake hydraulic pressure) transmitted through the piston 16 may be uniformly distributed to the back plate 122 and the friction material 123. Furthermore, as the distribution of the braking pressure is uniform, vibration and noise generation during the braking may be reduced, and as an abrasion surface of the friction material is uniform, a frequency and degree of braking vibration may be significantly reduced.

In addition, in the embodiment, the sliding protrusions 124 may be disposed at both sides of the pad 120, and also, the sliding protrusions 124 at both the sides may be inserted into and coupled to the guide grooves 111 of the torque member 110. An outer surface of each of the sliding protrusions 124 may have an arc shape. In this case, an inner surface of each of the guide grooves 111 at both the sides may also have an arc shape as illustrated in FIG. 5.

As a result, arc-shaped sliding contact may be provided between each of the sliding protrusions 124 at both the sides of the pad 120 and the inner surface of each of the guide grooves 111 of the torque member 110. Thus, when abnormal torque occurs, the abnormal torque may be resolved, and also, a frequency of occurrence of noise may be significantly reduced.

Referring to FIG. 5, it is seen that a clearance exists between a surface of the sliding protrusion and the inner surface of the guide groove, and thus, the sliding protrusion of the pad may be slid inside the guide groove of the torque member.

In addition, in the caliper unit in accordance with the prior art, the back plate of the pad is made of steel to minimize deformation, but in an embodiment, the back plate 122 of the pad 120 may be made of engineering plastic having excellent strength.

In an embodiment, the shape of the pad 120 and the disc contact area of the pad are similar to the shape of the piston 16 and the pad contact area of the piston 16, and thus, when the braking pressure is applied to the back plate 122 of the pad, only compressive force is generated between the piston 16, the friction material 123, and the disc 1 without lateral share force is generated in the back plate. As a result, engineering plastic having excellent compression resistance may be adopted as a material of the back plate 122.

In addition, in the pad 120, the heat dissipation plate 125 may be integrally attached and fixed between the back plate 122 and the friction material 123. Here, the heat dissipation plate 125 may cover an interface between the back plate 122 and the friction material 123 and an entire circumferential surface of a side end of the back plate 122.

As described above, the heat dissipation plate 125 is provided in a thin plate structure and installed to surround surfaces of front and side ends of the back plate 122. The heat dissipation plate 125 is constituted by a front part 125a that is a portion disposed between the back plate 122 and the friction material 123 and a side end cover part 125b integrally provided along the entire circumference of an edge of the front part 125a to cover the surface of the side end of the back plate.

The heat dissipation plate 125 may be made of a steel alloy material and may serve to uniformly transmit frictional heat generated between the disc and the friction material 123 of the pad 120 during the braking to the back plate 122 made of the engineering plastic and simultaneously serve to dissipate a portion of the frictional heat to air through the side end cover part 125b and also serve to reinforce strength of the back plate 122.

In addition, the heat dissipation plate 125 may be attached to surround the surface of the sliding protrusion 124 protruding from the back plate 122 to both left and right sides. Here, a portion of the heat dissipation plate 125, which surrounds the sliding protrusion 124 of the back plate 122 may prevent abrasion (abrasion of the sliding protrusion) of the back plate 122 when the sliding protrusion 124 slidably contacts along an inner surface of the guide groove 111 of the torque member 110 during the braking to secure abrasion resistance performance.

FIG. 8 is a cross-sectional view illustrating an example of various cross-sectional shapes of the heat dissipation plate in the pad of the caliper unit in accordance with an embodiment. As illustrated in the drawing, a cross-section of the front portion 125a of the heat dissipation plate 125 may have a shape in which a concave-convex shaped part is repeated to increase in bonding force and coupling force between both the sides while increasing in contact area between the heat dissipation plate 125 and the back plate 122 and between the heat dissipation plate 125 and the friction material 123. Referring to FIG. 8, an example in which the cross-section of the front part 125a of the heat dissipation plate 125 has a triangular teeth shape in which a mountain-valley shaped unevenness is repeated, or a square teeth shape in which concave and convex shapes are repeated is illustrated.

Here, even if the cross-section of the heat dissipation plate 125 has the repeatedly teeth shape, both surfaces of the heat dissipation plate, the back plate 122, and the friction material 123 are coupled to each other so as not to occur a clearance therebetween and so as to be completely in close contact with each other on the entire surface. For this, the pad 120 is manufactured so that the back plate 122 and the friction material 123 are in close contact with each other on both the surfaces of the heat dissipation plate 125. Here, after the heat dissipation plate 125 is manufactured so that the cross-section has a shape in which the concave-convex shaped part is repeated, the back plate 122 and the friction material 123 are thermally molded on both the surfaces of the heat dissipation plate so as to be mechanically coupled to each other.

In an area on which calcium chloride is widely sprayed on roads to remove snow in winter, there is a possibility that separation may occur due to corrosion of the contact surface between the back plate 122, the heat dissipation plate 125, and the friction material 123. However, when the heat dissipation plate 125 is manufactured in cross-section having the teeth shape as described above in a state in which the replacement cycle of the pad 120 increases, and the back plate 122 and the friction material 123 are press-molded on both the surfaces of the heat dissipation plate so as to be mechanically coupled to each other, the above-described separation may be solved.

Therefore, in the caliper unit for the brake in accordance with the present disclosure, the size, the weight, and the cost of the component may be reduced, and the fuel efficiency may be improved.

Although preferred embodiments of the present invention have been described for illustrative purposes, those skilled in the art will appreciate that various modifications, additions and substitutions are possible, without departing from the scope and spirit of the invention as disclosed in the accompanying claims. Therefore, the embodiments of the present invention are disclosed only for illustrative purposes and should not be construed as limiting the present invention.

1. A caliper unit for a brake, comprising:
an inner pad and an outer pad, which press both surfaces of a disc to generate braking force;
a torque member fixed to a vehicle body and coupled to be movable forward and backward so that the disc is pressed or released by the inner pad and the outer pad;
a caliper housing comprising a cylinder to which a brake hydraulic pressure is applied and a reaction force support part configured to press the outer pad to the disc; and
a piston installed in the cylinder and moving forward and backward depending on a state of the brake hydraulic pressure applied to the cylinder to press the inner pad to the disc,
wherein each of the inner pad and the outer pad has a circular shape, and
wherein a contact surface of the piston, which is in contact with the inner pad to press the inner pad during braking, has a circular shape.

2. The caliper unit of claim 1, wherein each of the inner pad and the outer pad has the same diameter as the contact surface of the piston or has a diameter greater than that of the contact surface of the piston.

3. The caliper unit of claim 1, wherein the inner pad and the outer pad comprise two sliding protrusions disposed at both sides, respectively,
Wherein the torque member has guide grooves guided to be slid in a state in which each of the sliding protrusion of the inner pad and the sliding protrusion of the outer pad are inserted, and
wherein an outer surface of each of the sliding protrusions has an arc shape, and an inner surface of each of the guide grooves has an arc shape, so that arc-shaped sliding contact is provided between each of the sliding protrusions and the inner surface of each of the guide grooves.

4. The caliper unit of claim 1, wherein each of the inner pad and the outer pad comprises:
a back plate;
a friction material which is a portion integrally coupled to the back plate with a heat dissipation plate therebetween and in contact with the disc to press the disc; and
a heat dissipation plate coupled to be interposed between the back plate and the friction material.

5. The caliper unit of claim 4, wherein the heat dissipation plate comprises:
a front part that is a portion interposed between a surface of the back plate and a surface of the friction material; and
a side end cover part integrally disposed along an entire circumference of an edge of the front part to cover a circumferential surface that is a surface of a side end of the back plate,
wherein a cross-section of the front part, on which the surface of the back plate and the surface of the friction material are bonded to be in close contact with each other, has a shape in which a concave-convex shaped part is repeated to increase the bonding force between the surface of the back plate and the surface of the fraction material.
